(19) United States
(12) Patent Application Publication
(10) Pub. No.: US 2025/0096833 A1
(43) Pub. Date: Mar. 20, 2025

(54) INTEGRATED CIRCUIT FOR WIRELESS POWER RECEIPTION AND BLUETOOTH COMMUNICATION AND BLUETOOTH COMMUNICATION METHOD USING THE SAME

(71) Applicant: 3A LOGICS INC., Gyeonggi-do (KR)

(72) Inventor: Sung Wan KIM, Gyeonggi-do (KR)

(21) Appl. No.: 18/758,633

(22) Filed: Jun. 28, 2024

(30) Foreign Application Priority Data
Sep. 15, 2023 (KR) 10-2023-0122979

(51) Int. Cl. H04B 1/38; H04W 4/80

(52) U.S. Cl. CPC H04B 1/38; H04W 4/80

(57) ABSTRACT

The present specification relates to an integrated circuit for wireless power supply and Bluetooth communication, and a Bluetooth communication method using the same. The integrated circuit includes: an antenna unit that receives a first radio frequency (RF) signal and a second RF signal from an external terminal; a power harvesting unit that generates power based on the first RF signal and the second RF signal; a radio frequency identification (RFID) tag that receives issuance data and initialization data included in the first RF signal through the antenna unit; a memory unit that is initialized by the initialization data, receives the issuance data from the RFID tag, and stores the issuance data; a Bluetooth low energy (BLE) transmitting unit that generates an output signal based on the issuance data and transmits the output signal to the external terminal through the antenna unit; a control unit that loads the issuance data from the memory unit and controls the BLE transmitting unit based on the issuance data; and a power storage unit that stores power generated from the power harvesting unit.

### CROSS-REFERENCE TO RELATED APPLICATION

This application claims priority to and the benefit of Korean Patent Application No. 2023-0122979, filed on Sep. 15, 2023, the disclosure of which is incorporated herein by reference in its entirety.

### BACKGROUND

### 1. Field of the Invention

The present invention relates to an integrated circuit for wireless power reception and Bluetooth communication and a Bluetooth communication method using the same, and more particularly, to an integrated circuit for wireless power reception and Bluetooth communication that is powered on in response to a radio frequency identification (RFID) frequency signal and a Bluetooth frequency signal transmitted from an external terminal, and a Bluetooth communication method using the same.

### 2. Discussion of Related Art

Beacons are wireless communication technologies that transmit or receive information to peripheral digital devices. The beacons are mainly used to interact with various devices through wireless communication and transmit and receive location information, state information, advertisements, etc. For example, the beacons may be connected to peripheral smartphones, tablets, computers, etc., to implement various applications.

The beacons usually operate using Bluetooth low energy (BLE), and the peripheral devices may detect signals transmitted from the beacons and perform appropriate operations accordingly. The beacons may receive signals only when peripheral devices are positioned within a predetermined distance, and thus, may be usefully used for location-based services, proximity notifications, etc.

BLE is being adopted for various Internet of Things (IoT) services that require short-range communication characteristics due to its small size, low cost, and low energy consumption functions. However, Bluetooth communication technology such as beacons requires constant power supply, and thus, has limitations in its implementation.

### RELATED ART DOCUMENT

### Patent Document

(Patent Document 1) Korean Patent Laid-Open Publication No. 10-2014-0091362 (Published on Jul. 21, 2014)
(Patent Document 2) Korean Patent Publication No. 10-0834841 (Published on Jun. 3, 2008)
(Patent Document 3) US Patent Publication No. U.S. Pat. No. 11,026,609 (Published Jun. 8, 2021)

### SUMMARY OF THE INVENTION

The present invention is directed to providing an integrated circuit for Bluetooth communication that is capable of receiving power wirelessly and a Bluetooth communication method using the same.

The present invention is also directed to providing an integrated circuit for Bluetooth communication that is capable of receiving power wirelessly using signals used in radio frequency identification (RFID) communication and signals used in Bluetooth communication, and a Bluetooth communication method using the same.

The present invention is also directed to providing an integrated circuit for Bluetooth communication that is capable of receiving advertising (ADV) data (or device information) required for an advertising procedure using RFID communication, in the integrated circuit for Bluetooth communication that includes a Bluetooth low energy (BLE) transmitting unit, and a Bluetooth communication method using the same.

According to an aspect of the present invention, there is provided an integrated circuit for Bluetooth communication, including: an antenna unit that receives a first RF signal and a second RF signal from an external terminal; a power harvesting unit that generates power based on the first RF signal and the second RF signal; an RFID tag that receives issuance data and initialization data included in the first RF signal through the antenna unit; a memory unit that is initialized by the initialization data, receives the issuance data from the RFID tag, and stores the issuance data; a BLE transmitting unit that generates an output signal based on the issuance data and transmits the output signal to the external terminal through the antenna unit; a control unit that loads the issuance data from the memory unit and controls the BLE transmitting unit based on the issuance data; and a power storage unit that stores power generated from the power harvesting unit.

The antenna unit may include: a first antenna unit that receives the first RF signal from the external terminal; a second antenna unit that receives the second RF signal from the external terminal; and a third antenna unit that transmits the output signal.

A frequency band of the first RF signal may be a frequency band for RFID communication, a frequency band of the second RF signal may be the frequency band for Bluetooth communication, and a frequency band of the output signal may be a frequency band of the second RF signal.

A frequency band of the first RF signal may be 900 MHZ, and a frequency band of the second RF signal may be 2.4 GHz.

The issuance data may include ADV data including device information and BLE control data including transmission information.

The first antenna unit may receive the first RF signal from an RFID reader of the external terminal, the second antenna unit may receive the second RF signal from a BLE transceiver unit of the external terminal, and the third antenna unit may transmit the output signal to the BLE transceiver unit.

According to another aspect of the present invention, there is provided a Bluetooth communication method including: receiving a first RF signal from an external terminal; generating and storing power using the first RF signal; storing issuance data in the first RF signal in a memory unit; receiving a second RF signal from the external terminal; generating and storing the power using the second RF signal; loading the issuance data from the memory unit; generating an output signal based on the issuance data; and transmitting the output signal to the external terminal using the same frequency band as the second RF signal.

The a first RF signal may be received through a first antenna unit, the second RF signal may be received through a second antenna unit, and the output signal may be transmitted through a third antenna unit.

A frequency band of the first RF signal may be a frequency band for RFID communication, and a frequency band of the second RF signal may be the frequency band for Bluetooth communication.

A frequency band of the first RF signal may be 900 MHZ, and a frequency band of the second RF signal may be 2.4 GHz.

The issuance data may include ADV data including device information and BLE control data including transmission information.

The generating of the output signal based on the issuance data may include performing a parameter setup process for generating the output signal based on the ADV data.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating an example of a wireless communication system using a Bluetooth low energy (BLE) technology proposed in the present specification;

FIG. 2 is a diagram illustrating an example of an internal block diagram of a device that may implement the methods proposed in the present specification;

FIGS. 3A and 3B are diagrams illustrating an example of Bluetooth communication architecture to which the methods proposed in the present specification may be applied;

FIG. 4 is a flowchart illustrating a method of forming a connection using BLE between devices;

FIG. 5 is a conceptual diagram schematically illustrating an external terminal and an integrated circuit for Bluetooth communication according to an embodiment of the present specification;

FIG. 6 is a plan view schematically illustrating the integrated circuit for Bluetooth communication of FIG. 5;

FIG. 7 is a conceptual diagram schematically illustrating an organic coupling relationship between components of the integrated circuit for Bluetooth communication of FIG. 5;

FIG. 8 is a conceptual diagram illustrating data transmission between the integrated circuit of FIG. 5 and the external terminal of FIG. 5;

FIG. 9 is a conceptual diagram illustrating energy transmission between the integrated circuit of FIG. 5 and the external terminal of FIG. 5; and

FIG. 10 is a flowchart schematically illustrating a Bluetooth communication method according to an embodiment of the present specification.

### DETAILED DESCRIPTION OF EXEMPLARY EMBODIMENTS

Objects, features, and advantages of the present specification will become more obvious from the following detailed description provided in relation to the accompanying drawings. However, the present specification may be variously modified and have several exemplary embodiments. Hereinafter, specific exemplary embodiments of the present specification will be illustrated in the accompanying drawings and be described in detail. In principle, same reference numerals denote same constituent elements throughout the specification. In addition, when it is determined that a detailed description for the known functions or configurations related to the present specification may obscure the gist of the present specification, detailed descriptions thereof will be omitted.

Hereinafter, a method and device related to the present specification will be described in more detail with reference to the drawings. In addition, the terms “module” and “unit” for components used in the following description are used only to easily make the specification. Therefore, these terms do not have meanings or roles that distinguish from each other in themselves.

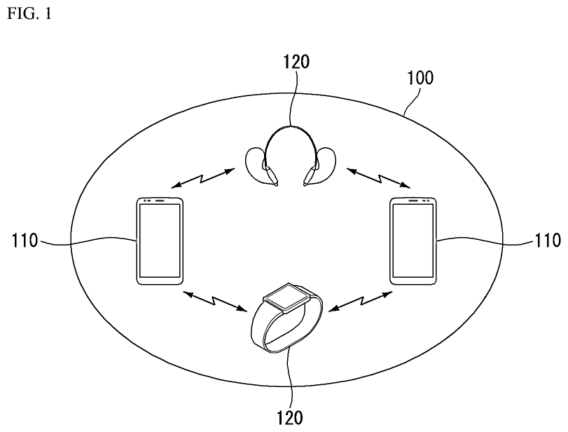

FIG. 1 is a schematic diagram illustrating an example of a wireless communication system using a Bluetooth low energy (BLE) technology proposed in the present specification.

A wireless communication system 100 includes at least one server device 120 and at least one client device 110.

The server device and the client device perform Bluetooth communication using a Bluetooth low energy (hereinafter referred to as “BLE” for convenience) technology.

First, compared to Bluetooth basic rate/enhanced data rate (Bluetooth BR/EDR) technology, the BLE technology may have a relatively small duty cycle, may be produced at a low price, and can significantly reduce power consumption through a low-speed data transmission rate to operate a coin cell battery for a year or longer.

In addition, in the BLE technology, a connecting procedure between devices is simplified, and a packet size is also designed to be smaller than that of Bluetooth BR/EDR technology.

The server device 120 may operate as a client device in the relationship with other devices, and the client device may operate as a server device in the relationship with other devices. That is, in a BLE communication system, any one device can operate as a server device or a client device, and if necessary, operate as the server device and the client device simultaneously.

The server device 120 may be expressed as a data service device, a slave device, a slave, a server, a conductor, a host device, a gateway, and a sensing device, a monitoring device, a first device, a first data logger, etc., and the client device 110 may be expressed as a master device, a master, a client, a member, a sensor device, a sink device, a collector, a second device, a second data logger, etc.

The server device and the client device correspond to main components of the wireless communication system, and the wireless communication system may include other components in addition to the server device and the client device.

The server device is a device that receives data from a client device, communicates directly with the client device, and provides data to the client device through a response upon receiving a data request from the client device.

In addition, the server device transmits a notification message and an indication message to the client device to provide data information to the client device. In addition, when the server device transmits the indication message to the client device, the server device receives a confirm message corresponding to the indication message from the client.

In addition, the server device may provide data information to a user through a display unit or receive a request input from the user through the user input interface while transmitting and receiving notifications, indications, and confirm messages to and from the client device.

In addition, the server device may read data from a memory unit or write new data to the memory unit while transmitting and receiving messages to and from the client device.

In addition, one server device may be connected to a plurality of client devices, and easily reconnected to (or access) the client devices using bonding information.

The client device 110 is a device that requests data information and data transmission from and to the server device.

The client device receives data through the notification message, the indication message, etc., from the server device, and transmits the confirm message in response to the indication message upon receiving the indication message from the server device.

Similarly, the client device may also provide information to a user through the display unit or receive input from the user through the user input interface while transmitting and receiving the messages to and from the server device.

In addition, the client device may read data from a memory unit or write new data to the memory unit while transmitting and receiving messages to and from the server device.

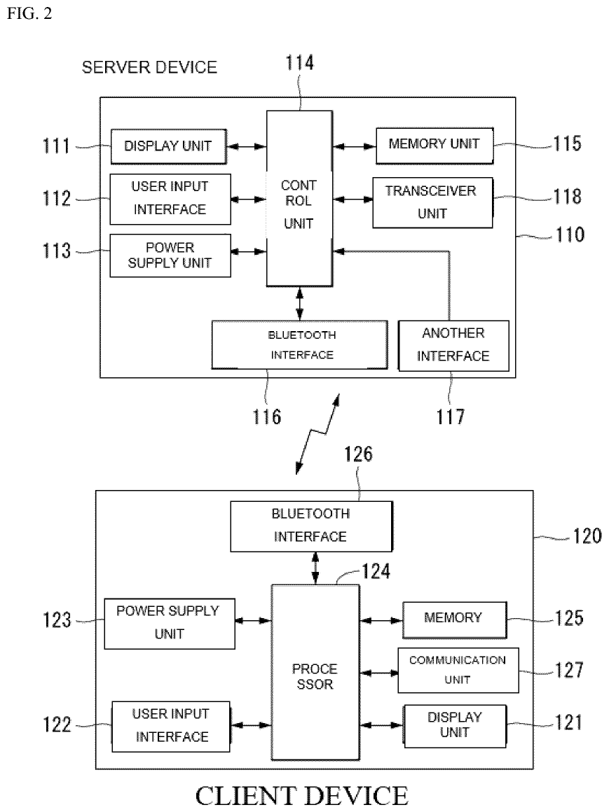

Hardware components such as the display unit, the user input interface, and the memory unit of the server device and the client device will be described in detail with reference to FIG. 2.

In addition, the wireless communication system may establish personal area networking (PAN) through Bluetooth technology. For example, in the wireless communication system, files, documents, etc., may be exchanged quickly and safely by establishing a private piconet between the devices.

FIG. 2 is a diagram illustrating an example of an internal block diagram of a device that may implement the methods proposed in the present specification.

As illustrated in FIG. 2, the server device includes a display unit 111, a user input interface 112, a power supply unit 113, a processor 114, a memory unit 115, a Bluetooth interface 116, another interface 117, and a communication unit (or transceiver unit) 118.

The display unit 111, the user input interface 112, the power supply unit 113, the processor 114, the memory unit 115, the Bluetooth interface 116, another interface 117, and the communication unit 118 are functionally connected to perform the methods proposed in the present specification.

In addition, the client device includes a display unit 121, a user input interface 122, a power supply unit 123, a processor 124, a memory unit 125, a Bluetooth interface 126, and a communication unit (or transceiver unit) 127.

The display unit 121, the user input interface 122, the power supply unit 123, the processor 124, the memory unit 125, the Bluetooth interface 126, and the communication unit 118 are functionally connected to perform the methods proposed in the present specification.

The Bluetooth interfaces 116 and 126 refer to units (or modules) capable of transmitting requests/responses, commands, notifications, indications/confirm messages, etc., or data between the devices using the Bluetooth technology.

The memory units 115 and 125 are units implemented in various types of devices and refer to units in which various types of data are stored.

The processors 114 and 124 refer to modules that control the overall operation of the server device or client device, and perform control so that a transmission request of messages and received messages through the Bluetooth interface and another interface are processed.

The processors 114 and 124 may be expressed as a control part, a control unit, a controller, etc.

The processors 114 and 124 may include an application-specific integrated circuit (ASIC), other chipsets, logic circuits, and/or data processing devices.

The processors 114 and 124 control the communication unit to receive advertising messages from the server device, transmit a scan request message to the server device, control the communication unit to receive a scan response message in response to the scan request from the server device, and controls the communication unit to transmit a connect request message to the server device to establish a Bluetooth connection with the server device.

In addition, the processors 114 and 124 controls the communication unit to read or write data using an ATT from the server device after a BLE connection is formed through the connecting procedure.

The memory units 115 and 125 may include a read-only memory (ROM), a random access memory (RAM), a flash memory unit, a memory unit card, a storage medium, and/or other storage devices.

The communication units 118 and 127 may include a baseband circuit for processing wireless signals. When the embodiment is implemented in software, the above-described technique may be implemented as a module (process, function, etc.) performing the above-described function. The module is stored in the memory unit and may be executed by the processor.

The memory units 115 and 125 may be disposed inside or outside the processors 114 and 124 and connected to the processors 114 and 124 by various well-known means.

The display units 111 and 121 are modules for providing device state information, message exchange information, etc., to a user through a screen.

The power supply units 113 and 123 are modules that receive external power and internal power under the control of the control unit and supply power necessary for the operation of each component.

As described above, the BLE technology has a small duty cycle and may significantly reduce power consumption through a low data transmission rate, and the power supply unit may supply power required for the operation of each component even with low output power (10 mW (10 dBm) or less).

The user input interface 112 and 122 are modules that allow a user to control the operation of the device by providing user input, such as a screen button, to the control unit.

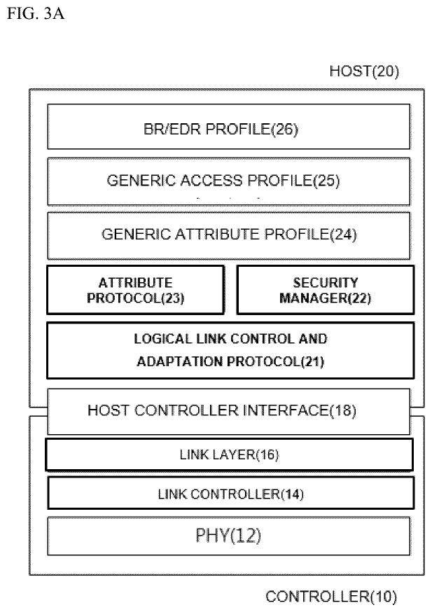

FIGS. 3A and 3B are diagrams illustrating an example of Bluetooth communication architecture to which the methods proposed in the present specification may be applied.

Referring to FIGS. 3A and 3B, FIG. 3A illustrates an example of a Bluetooth basic rate (BR)/enhanced data rate (EDR) protocol stack, and FIG. 3B represents an example of a BLE protocol stack.

Specifically, as illustrated in FIG. 3A, the Bluetooth BR/EDR protocol stack may include an upper controller stack 10 and a lower host stack 20 based on a host controller interface (HCI) 18.

The host stack (or host module) 20 is a wireless transceiver module that receives a 2.4 GHz Bluetooth signal and hardware for transmitting or receiving Bluetooth packets, and is connected to the Bluetooth module, which is the controller stack 10, to perform an operation of controlling the Bluetooth module.

The host stack 20 may include a Bluetooth basic rate/enhanced data rate physical (BR/EDR PHY) 12, a BR/EDR baseband layer 14, and a link manager layer 16.

The BR/EDR PHY layer 12 is a layer that transmits and receives 2.4 GHz wireless signals, and when using Gaussian frequency shift keying (GFSK) modulation, may transmit data by hopping 79 RF channels.

The BR/EDR baseband layer 14 is responsible for transmitting digital signals, selects a channel sequence that hops 1400 times per second, and transmits a time slot of 625 μs for each channel.

The link manager layer 16 uses a link manager protocol (LMP) to control the overall operations (link setup, control, security) of the Bluetooth connection.

The link manager layer 16 may perform the following functions.
Perform asynchronous connectionless link (ACL)/synchronous connection-oriented (SCO) logical transport, logical link setup, and control.
Detach: Stop the connection and informs other devices of the reason for the stop.
Perform power control and role switch.
Perform security (authentication, pairing, encryption) functions.

The host controller interface layer 18 may provide an interface between the host module and the controller module to allow the host to provide commands and data to the controller and the controller to provide events and data to the host.

The host stack (or host module, 20) includes a logical link control and adaptation protocol (L2CAP) 21, a security manager (SM) 22, an attribute protocol (ATT) 23, a generic attribute profile (GATT) 24, a generic access profile (GAP) 25, and a BR/EDR profile 26.

The L2CAP 21 may provide one two-way channel for transmitting data to a specific protocol or a profile.

The L2CAP 21 is capable of multiplexing various protocols, profiles, etc., provided on Bluetooth.

The L2CAP of the Bluetooth BR/EDR uses a dynamic channel, supports a protocol service multiplexer, a retransmission, and a streaming mode, and provides segmentation and reassembly, per-channel flow control, and error control.

The SM 22 is a protocol for authenticating devices and providing key distribution.

The GATT 24 can operate as a protocol that describes how the ATT 23 is used when configuring services. For example, the GATT 24 can operate to specify how the ATT attributes are grouped together into services and operate to describe features linked with the services.

Accordingly, the GATT 24 and the ATT 23 may use features to describe the state and services of the devices, how the features are associated with each other and how the features are used.

The ATT 23 and profile 26 define a service (profile) using the Bluetooth BR/EDR and an application protocol for exchanging the data, and the GAP 25 defines a method of device discovery, connection, and provision of information to a user, and provides privacy.

As illustrated in FIG. 3B, the BLE protocol stack includes a controller stack 30 that can operate to process a timing-critical wireless device interface and a host stack 40 that can operate to process high level data.

First, the controller stack 30 may be implemented using a communication module that may include a Bluetooth wireless device, for example, a processor module that may include a processing device such as a microprocessor.

The host stack may be implemented as part of an operating system (OS) running on a processor module, or as an instantiation of a package on the OS.

In some instances, the controller stack and host stack may operate or execute on the same processing device within the processor module.

The controller stack 30 includes a PHY 32, a link layer (LL) 34, and an HCI 36.

The PHY (wireless transceiver module) 32 is a layer that transmits and receives 2.4 GHz wireless signals and uses a frequency hopping technique that includes GFSK modulation and 40 RF channels.

The LL 34, which serves to transmit or receive Bluetooth packets, provides a function of performing advertising and scanning functions using three advertising channels, generating a connection between devices, and then transmitting and receiving data packets of up to 257 bytes through 37 data channels.

The host stack includes a GAP 40, an L2CAP 41, an SM 42, an ATT 440, and a GATT 44, a GAP 25, and an LT profile 46. However, the host stack 40 is not limited thereto and may include various protocols and profiles.

The host stack uses the L2CAP to multiplex various protocols and profiles provided on Bluetooth.

First, the L2CAP 41 may provide one two-way channel for transmitting data to a specific protocol or profile.

The L2CAP 41 can operate to multiplex data between upper layer protocols, segment and reassemble packages, and manage multicast data transmission.

The BLE uses three fixed channels (one for signaling CH, one for SM, and one for ATT).

On the other hand, the BR/EDR uses the dynamic channel and supports the protocol service multiplexer, the retransmission, the streaming mode, etc.

The SM 42 is a protocol for authenticating devices and providing key distribution.

The ATT 43 defines rules for accessing data of the other device in a server-client structure. The ATT has the following six message types (request, response, command, notification, indication, and confirmation).
\textcircled{1} Request and response messages: Request message is a message to request specific information from a client device to a server device, and a response message is a response message to the request message and is a message transmitted from the server device to the client device.
\textcircled{2} Command message: Message transmitted from the client device to the server device to indicate a command for a specific operation. The server device does not transmit a response to the command message to the client device.
\textcircled{3} Notification message: Message transmitted from the server device to the client device for notification of events, etc. The client device does not transmit the confirm message for the notification message to the server device.
\textcircled{4} Indication and confirm message: Message transmitted from the server device to the client device for notification of events, etc. Unlike the notification message, the client device transmits the confirm message for the indication message to the server device.

This specification may transmit a value for a data length when requesting long data in the GATT profile using the ATT 43 to allow the client to clearly know the data length, and use a universally unique identifier (UUID) to acquire characteristic values information from the server.

The GAP 45 is a newly implemented layer for the BLE technology and is used to control role selection for communication between the BLE devices and how multi-profile operation occurs.

In addition, the GAP 45 is mainly used in device discovery, connection generation, and security procedure, defines a method of providing information to a user, and defines types of attributes as follows.
\textcircled{1} Service: Defines a basic operation of the device as a combination of data-related behaviors
\textcircled{2} Include: Defines the relationship between services
\textcircled{3} Characteristics: Data values used in services
\textcircled{4} Behavior: Computer-readable format defined as UUID (value type)

The LE profiles 46 are profiles dependent on the GATT and are mainly applied to BLE devices. The LE profile 46 may include, for example, battery, time, FindMe, proximity, time, object delivery service, etc., and the specific contents of GATT-based profiles are as follows.
\textcircled{1} Battery: Method of exchanging battery information
\textcircled{2} Time: Method of exchanging time information
\textcircled{3} FindMe: Provides an alarm service based on distance
\textcircled{4} Proximity: Method of exchanging battery information
\textcircled{5} Time: Method of exchanging time information

The GATT 44 can operate as a protocol that describes how the ATT 43 is used when configuring services. For example, the GATT 44 can operate to specify how the ATT attributes are grouped together into services and operate to describe features linked with the services.

Accordingly, the GATT 44 and the ATT 43 may use features to describe the state and services of the devices, how the features are associated with each other and how the features are used.

Hereinafter, the procedures of the BLE technology will be briefly described.

The BLE procedure may be divided into a device filtering procedure, an advertising procedure, a scanning procedure, a discovering procedure, a connecting procedure, etc.

### Device Filtering Procedure

The device filtering procedure is a method of reducing the number of devices that performs a response to request, indication, notification, etc., in a controller stack.

When the request is received from all devices, it is not necessary to respond to the request, so the controller stack may perform control so that power consumption is reduced in the BLE controller stack by reducing the number of transmitted requests.

An advertising device or scanning device may perform the device filtering procedure to limit devices that receive advertising packets, scan requests, or connection requests.

Here, the advertising device is a device that transmits advertising events, that is, performs advertising, and is also expressed as an advertiser.

The scanning device is a device that performs scanning or a device that transmits a scan request.

In the BLE, when the scanning device receives some advertising packets from the advertising device, the scanning device should transmit the scan request to the advertising device.

However, when the device filtering procedure is used and the transmission of the scan request is unnecessary, the scanning device may ignore the advertising packets transmitted from the advertising device.

The device filtering procedure may be used even in the connection request process. When the device filtering is used in the connection request process, there is no need to transmit the response to the connection request by ignoring the connection request.

### Advertising Procedure

The advertising device performs an advertising procedure to perform a non-directional broadcast to devices within an area.

Here, the non-directional broadcast is broadcast in omni (all) direction rather than broadcast in a specific direction.

In contrast, the directional broadcast is broadcast in a specific direction. The non-directional broadcast occurs without a connecting procedure between the advertising device and a device in a listening (or hearing) state (hereinafter referred to as a listening device).

The advertising procedure is used to establish a Bluetooth connection with a nearby initiating device.

Alternatively, the advertising procedure may be used to provide periodic broadcasts of user data to the scanning devices that are listening on the advertising channel.

In the advertising procedure, all advertisements (or advertising events) are broadcast through an advertising physical channel.

The advertising devices may receive the scan request from the listening devices that are listening to obtain additional user data from the advertising device. The advertising device transmits the response to the scan request to the device that transmits the scan request through the same advertising physical channel as the advertising physical channel that receives the scan request.

Broadcast user data transmitted as part of the advertising packets is dynamic data, whereas the scan response data is generally static data.

The advertising device may receive the connection request from the initiating device on the advertising (broadcast) physical channel. When the advertising device uses a connectable advertising event and the initiating device is not filtered by the device filtering procedure, the advertising device stops advertising and enters a connection mode. The advertising device may start advertising again after entering the connection mode.

### Scanning Procedure

The device that performs scanning, that is, the scanning device, performs the scanning procedure to listen to the non-directional broadcast of the user data from the advertising devices using the advertising physical channel.

The scanning device transmits the scan request to the advertising device through the advertising physical channel to request additional user data from the advertising device. The advertising device transmits the scan response, which is the response to the scan request, including additional user data requested by the scanning device through the advertising physical channel.

The scanning procedure may be used while connected to other BLE devices in a BLE piconet.

When the scanning device receives a broadcasted advertising event and is in an initiator mode that may initiate the connection request, the scanning device transmits the connection request to the advertising device through the advertising physical channel, thereby starting a Bluetooth connection with the advertising device.

When the scanning device transmits the connection request to the advertising device, the scanning device stops scanning the initiator mode for additional broadcast and enters the connection mode.

### Discovering Procedure

Devices (hereinafter referred to as ‘Bluetooth devices’) capable of Bluetooth communication perform the advertising and scanning procedures to discover devices existing nearby or to be discovered by other devices within a given area.

The discovering procedure is performed asymmetrically. The Bluetooth device that tries to find other devices existing nearby is referred to as a discovering device, and listens to find devices that advertise scannable advertising events. The Bluetooth device that can be discovered and used by other devices is called a discoverable device, and actively broadcasts the advertising event so that other devices can scan the advertising event through the advertising (broadcast) physical channel.

Both the discovering device and the discoverable device may already be connected to other Bluetooth devices in the piconet.

### Connecting Procedure

The connecting procedure is asymmetric, and the connecting procedure requires a specific Bluetooth device to perform the advertising procedure while other Bluetooth devices perform the scanning procedure.

That is, the advertising procedure may be an objective, and as a result, only one device will respond to the advertising. After receiving the connectable advertising event from the advertising device, the connection may be initiated by transmitting the connection request to the advertising device through the advertising (broadcast) physical channel.

Next, the operation state in the BLE technology, that is, the advertising state, the scanning state, the initiating state, and the connection state will be briefly described.

### Advertising State

The LL enters the advertising state by the indication of the host (stack). When the LL is in the advertising state, the LL transmits advertising packet data units in the advertising events.

Each advertising event is composed of at least one advertising PDU, and the advertising PDUs are transmitted through advertising channel indices used. The advertising event may be terminated when each advertising PDU is transmitted through the advertising channel indices used, or the advertising event may be terminated earlier when the advertising device needs to secure a space to perform other functions.

### Scanning State

The LL enters the advertising state by the indication of the host (stack). In the scanning state, the LL listens to the advertising channel indices.

There are two types of scanning states: passive scanning and active scanning. Each scanning type is determined by the host.

No separate time or advertising channel index is defined for performing the scanning.

During the scanning state, the LL listens to the advertising channel index in a scanWindow duration. ScanInterval is defined as an interval between starting points of two consecutive scan windows.

The LL should perform listening for the completion of all scan intervals of the scan window as indicated by the host, when there are no scheduling conflicts. In each scan window, the LL should scan a different advertising channel index. The LL uses all available advertising channel indices.

When performing the passive scanning, the LL only receives packets and does not transmit any packets.

When performing the active scanning, the LL performs listening to rely on advertising PDUs and an advertising PDU type that may request additional information related to the advertising device from the advertising device.

### Initiating State

The LL enters the initiating state by the indication of the host (stack).

When the LL is in the initiating state, the LL performs the listening for the advertising channel indices.

During the initiating state, the LL listens to the advertising channel index during the scan window duration.

### Connection State

The LL enters the connection state when the device performing the connection request, that is, the initiating device, transmits CONNECT_REQ PDU to the advertising device, or when the advertising device receives the CONNECT_REQ PDU from the initiating device.

After entering the connection state, the connection is considered generated. However, there is no need to consider establishing the connection at the time when the connection enters the connection state. The only difference between a newly generated connection and the previously established connection is an LL connection supervision timeout value.

When two devices are connected, the two devices act in different roles.

The LL performing the master role is called a master, and the LL performing the slave role is called a slave. The master controls the timing of the connection event, and the connection event refers to the time when the master and slave are synchronized with each other.

Hereinafter, packets defined in the Bluetooth interface will be briefly described. The BLE devices use packets defined below.

### Packet Format

The LL has only one packet format used for both advertising channel packets and data channel packets.

Each packet is composed of four fields: preamble, access address, PDU, and cyclic redundancy checking (CRC).

When one packet is transmitted on the advertising physical channel, the PDU will be an advertising channel PDU, and when one packet is transmitted on the data physical channel, the PDU will be a data channel PDU.

### Advertising Channel PDU

The advertising channel PDU has a 16-bit header and payloads of various sizes.

A PDU type field of the advertising channel PDU included in the header indicates the PDU type as defined in Table 1 below.

TABLE 1

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

### Advertising PDU

The advertising channel PDU types below are called advertising PDUs and are used in specific events.
ADV_IND: connectable non-directional advertising event
ADV_DIRECT_IND: connectable directional advertising event
ADV_NONCONN_IND: Non-directional advertising event not connectable
ADV_SCAN_IND: Scannable non-directional advertising event

The PDUs are transmitted in the LL in the advertising state and received by the LL in the scanning state or initiating state.

### Scanning PDU

The advertising channel PDU type below is called a scanning PDU and is used in the conditions described below.

SCAN_REQ: Transmitted by the LL in the scanning state and received by LL in the advertising state.

SCAN_RSP: Transmitted by the LL in the advertising state and received by the LL in the scanning state.

### Initiating PDU

The advertising channel PDU type below is called an initiating PDU.

CONNECT_REQ: Transmitted by the LL in the initiating state and received by the LL in the advertising state.

### Data Channel PDU

The data channel PDU has a 16-bit header, a payload of various sizes, and may include a message integrity check (MIC) field.

The procedures, states, packet formats, etc., in the BLE technology disclosed above may be applied to perform the methods proposed in this specification.

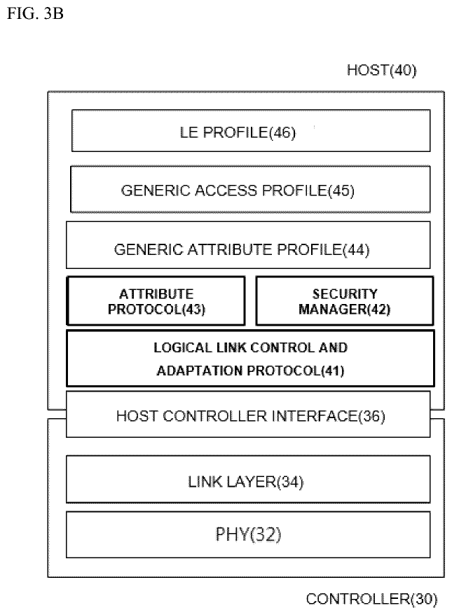

FIG. 4 is a flowchart illustrating a method of forming a connection using BLE between devices.

As illustrated in FIG. 4, for BLE connection between a first device 300 and a second device 400, the first device 300 transmits an advertising message to the second device (S6010).

As disclosed above, the advertising message is used to provide its own information to other devices using the BLE, and may include various types of information such as service information and user information provided by the device.

After confirming the information included in the advertising message transmitted by the first device 300, the second device 400 transmits a connection request message to request a BLE connection to the first device 300 (S6020), and the first device 300 and the second device 400 form the BLE connection (S6030).

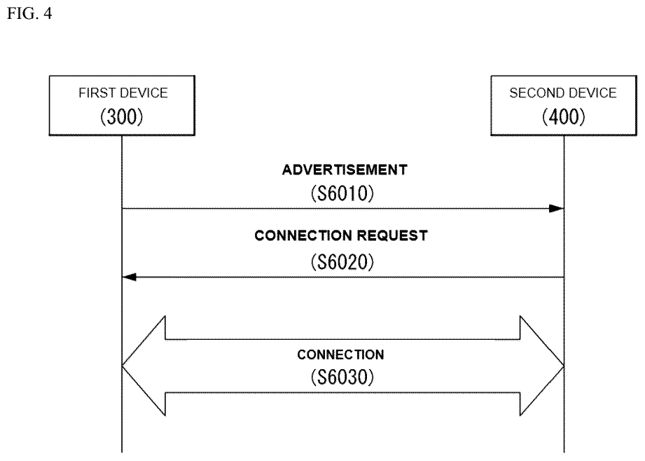

FIG. 5 is a conceptual diagram schematically illustrating the external terminal and the integrated circuit for Bluetooth communication according to an embodiment of the present specification.

For reference, in the description of FIG. 5, contents that are the same or overlapping with the contents described above may be omitted.

As illustrated in FIG. 5, an external terminal 500 may include a processor 510, a memory 520, an RFID reader 530, and a BLE transceiver unit 540.

The processor 510 may control other components by executing instructions stored in the memory 520. The processor 510 may execute instructions stored in the memory 520. The processor 510 is a component that may perform calculations and control other devices. Mainly, the processor 510 may mean a central processing unit (CPU), an application processor (AP), a graphics processing unit (GPU), etc.

The processor 510 may provide or process appropriate information or a function to a user by processing signals, data, information, and the like, which are input or output through the above-described components, or by driving an application program stored in the memory 520.

The memory 520 stores data and/or instructions that support various functions of the external terminal 500. The memory 520 may store a plurality of application programs or applications that are driven by the external terminal 500, and data and instructions for operating the external terminal 500. At least some of these application programs may be downloaded from the external server via the wireless communication. In addition, the application program may be stored in the memory 520, installed on the external terminal 500, and driven to perform the operation (or function) of the external terminal 500 by the processor 510.

The memory 520 may include at least one of a flash memory type storage medium, a hard disk type storage medium, a solid state disk type (SSD type), a silicon disk drive type (SDD type), a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The memory 520 may include web storage that performs a storage function on the Internet.

The RFID reader 530 may refer to a device that transmits and receives information to and from a tag (for example, an RFID tag 621 to be described below) to utilize the information of the tag or transmits information collected from the tag to a back-end system. The RFID reader 530 may be a fixed reader that reads a moving tag and is connected to the back-end system and the wired network, or a mobile reader that reads a fixed tag and is connected to the back-end and the wireless network.

For example, the RFID reader 530 may transmit a first RF signal to an antenna unit 610 to be described below, and receive UID information through the antenna unit 610 to be described below. As a result, the RFID reader 530 may identify an electronic circuit to be described below.

The BLE transceiver unit may transmit the second RF signal to the antenna unit 610 to be described below, and receive the output signal through the antenna unit 610 to be described below. As a result, the BLE transceiver unit 540 may perform the advertising procedure described above

The RFID reader 530 and the BLE transceiver unit 540 may be controlled by the processor 510 that executes instructions stored in the memory 520. The RFID reader 530 and the BLE transceiver unit 540 may be controlled by the processor 510 according to preset values or controlled by the processor 510 according to the user input received from the user.

As illustrated in FIG. 5, an integrated circuit 600 for Bluetooth communication may include an antenna unit 610, a chip mounting unit 620, and a power storage unit 630.

The antenna unit 610 may receive the first RF signal and the second RF signal from the external terminal 500. The antenna unit 610 may include at least one antenna, and the antenna unit 610 may be electrically connected to the chip mounting unit 620 to be described below. As a result, the chip mounting unit 620, which will be described below, can receive the first RF signal and the second RF signal through the antenna unit 610.

The chip mounting unit 620 may be a system on chip (SoC). For example, the chip mounting unit 620 may include a substrate and a plurality of chips mounted on the substrate, and each chip may perform a predetermined function. For example, the chip mounting unit 620 may include an RFID tag 621, a power harvesting unit 622, a BLE transmitting unit 623, a memory unit 624, and a control unit 625.

The RFID tag 621 may receive the issuance data and initialization data included in the first RF signal through the antenna unit 610. For example, when the RFID reader 530 of the external terminal 500 is tagged to the RFID tag 621, the RFID tag 621 may be activated by receiving the first RF signal and turned on. For example, the issuance data may include the ADV data including the device information and the BLE control data including the transmission information.

For example, the ADV data may include device ID information, information issuance time information, etc. The ADV data may refer to information necessary for the BLE transmitting unit 623 to perform the advertising procedures required for the BLE communication (e.g., beacon).

For example, the BLE control data may include transmission interval information, transmission power information, wakeup period information of the Bluetooth communication integrated circuit 600, etc., in the BLE transmitting unit 623.

The power harvesting unit 622 may receive the first RF signal through the antenna unit 610 and generate power by inducing power according to the first RF signal. In addition, the power harvesting unit 622 may receive the second RF signal through the antenna unit 610 and generate power by inducing power according to the second RF signal. For example, the power harvesting unit 622 may generate power based on the first RF signal and the second RF signal received from the external terminal 500.

The BLE transmitting unit 623 may operate based on the control of the control unit 625 to be described below. The BLE transmitting unit 623 may transmit data stored in the memory unit 624 to be described below to the external terminal 500 using low-power Bluetooth communication technology. For example, the BLE transmitting unit 623 may transmit the output signal generated from the control unit 625 to be described below to the external terminal 500.

The BLE transmitting unit 623 is a component that transmits data and does not receive separate data. Accordingly, data (e.g., beacon) required for the BLE communication (e.g., issuance data) may be acquired through the RFID tag 621 described above. As a result, the integrated circuit for Bluetooth communication according to the present specification has the remarkable effect of being able to implement the BLE communication using the power harvesting technology of the RFID communication even without a separate constant power supply.

The memory unit 624 is a non-volatile memory and may be ROM, EEPROM, or PROM. The memory unit 624 may store the issuance data included in the first RF signal. The memory unit 624 may receive sensing data, etc., from other components and store the sensing data. The memory unit 624 may store pre-input data, instructions, etc.

For example, the sensing data may be temperature data. The sensing data may be acquired from a temperature sensing chip (not illustrated) mounted on an integrated circuit. The sensing data may be data acquired by the temperature sensing chip (not illustrated) and then pre-stored in the memory unit 624.

The control unit 625 may control other components based on instructions, etc., stored in the memory unit 624. The control unit 625 may generate the output signal based on the issuance data included in the first RF signal. For example, the control unit 625 may transmit the output signal to the BLE transmitting unit 623 and transmit the output signal to the external terminal 500 through the BLE transmitting unit 623.

The power storage unit 630 may be configured to store power generated from the power harvesting unit and supply power to other components. For example, the power storage unit 630 may be a capacitor, a multi-layer ceramic capacitor (MLCC), or the like.

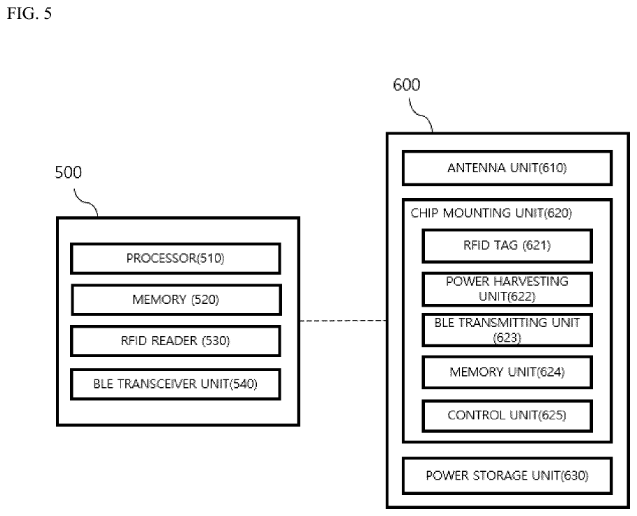

FIG. 6 is a plan view schematically illustrating the integrated circuit for Bluetooth communication of FIG. 5.

For reference, in the description of FIG. 6, contents that are the same or overlapping with the contents described above may be omitted.

As illustrated in FIG. 6, the antenna unit 610 may include a first antenna unit 611, a second antenna unit 612, and a third antenna unit 613. For example, the first antenna unit 611 may receive the first RF signal from the external terminal 500 and transmit the received first RF signal to the RFID transceiver unit or to the power harvesting unit 622.

For example, the second antenna unit 612 may receive the second RF signal from the external terminal 500 and transmit the received second RF signal to the power harvesting unit 622. For example, the third antenna unit 613 may receive the output signal generated by the control unit 625 from the BLE transmitting unit 623 and transmit the output signal to the external terminal 500.

For example, the second antenna unit 612 and the third antenna unit 613 may be disposed on both sides of the chip mounting unit 620.

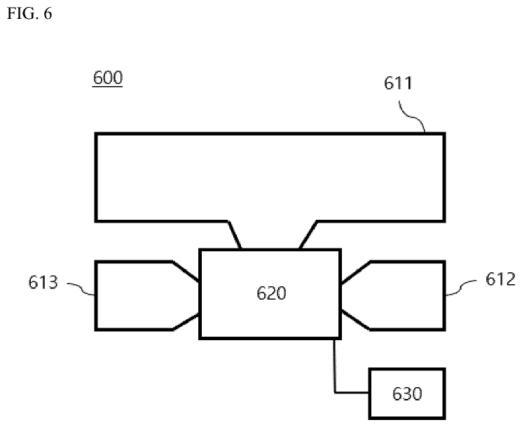

FIG. 7 is a conceptual diagram schematically illustrating the organic coupling relationship between components of the integrated circuit for Bluetooth communication of FIG. 5.

For reference, in the description of FIG. 7, contents that are the same or overlapping with the contents described above may be omitted.

As illustrated in FIG. 7, the RFID transceiver unit may be electrically connected to the first antenna unit 611 and electrically connected to the memory unit 624. As a result, the RFID transceiver unit may receive the issuance data in the first RF signal and store the issuance data in the memory unit 624.

The power harvesting unit 622 may be electrically connected to the first antenna unit 611 and the second antenna unit 612. The power harvesting unit 622 may generate power by deriving the power from the first RF signal received from the first antenna unit 611. The power harvesting unit 622 may derive and generate power from the second RF signal received from the second antenna unit 612. The power harvesting unit 622 may be electrically connected to the power storage unit 630 and store power by transferring the generated power to the power storage unit 630. In addition, the power generated by the power harvesting unit 622 may be used to drive the RFID transceiver unit, the memory unit 624, the BLE transmitting unit 623, and the control unit 625.

However, the power harvesting unit 622 may not produce power by being limited to Bluetooth standard signals. For example, the second antenna unit 612 may also receive communication signals of other standards, such as Wi-Fi signals and ZigBee signals, together as long as it has the same frequency band as the second RF signal. As a result, the power harvesting unit 622 may induce and generate power from the communication signals of other standards, such as the Wi-Fi signals and the ZigBee signals.

The BLE transmitting unit 623 may be electrically connected to the third antenna unit 613 and electrically connected to the control unit 625. The BLE transmitting unit 623 may receive the output signal from the control unit 625 and transmit the output signal to the external terminal 500 through the third antenna unit 613 based on the Bluetooth communication standard.

The control unit 625 may be electrically connected to the memory unit 624 and may be electrically connected to the BLE transmitting unit 623. The control unit 625 may generate the output signal based on the data stored in the memory unit 624.

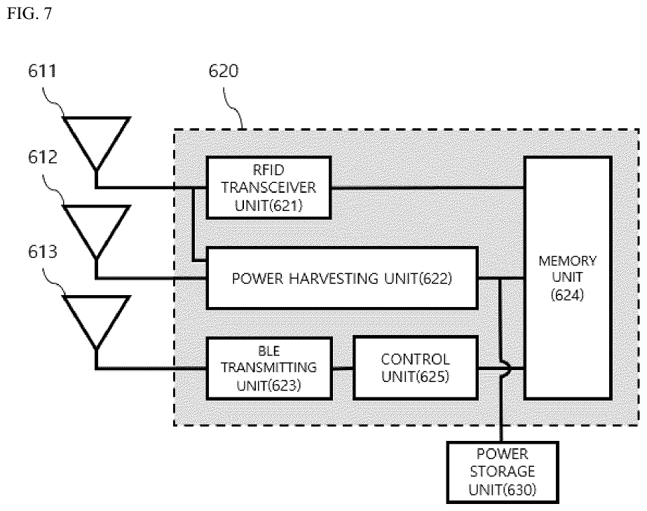

FIG. 8 is a conceptual diagram illustrating data transmission between the integrated circuit of FIG. 5 and the external terminal of FIG. 5.

For reference, in the description of FIG. 8, contents that are the same or overlapping with the contents described above may be omitted.

As illustrated in FIG. 8, a frequency band of the first RF signal may be a frequency band for RFID communication. For example, the frequency band of the first RF signal may be a 900 MHz frequency band. This may be equally applied to examples in other drawings.

The frequency band of the second RF signal may be a frequency band for Bluetooth communication. For example, the frequency band of the second RF signal may be 2.4 GHz, which is a frequency band for low-power Bluetooth communication. In addition, according to the Bluetooth communication standard, the frequency band of the second RF signal may have a different frequency, such as 5 GHz. This may be equally applied to examples in other drawings.

The RFID reader 530 may transmit and receive data to and from the RFID tag 621 through the first antenna unit 611. In this case, data may be transmitted and received in the frequency band of the above-described first RF signal and transmitted in both directions.

The BLE transceiver unit 540 may receive data from the BLE transmitting unit 623 through the third antenna unit 613. In this case, the data may be transmitted in the frequency band of the second RF signal described above and transmitted unidirectionally.

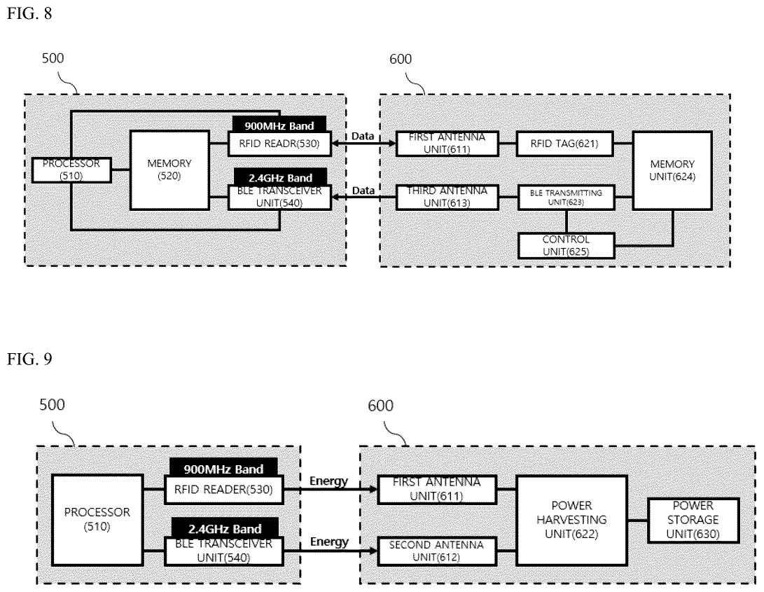

FIG. 9 is a conceptual diagram illustrating energy transmission between the integrated circuit of FIG. 5 and the external terminal of FIG. 5.

For reference, in the description of FIG. 9, contents that are the same or overlapping with the contents described above may be omitted.

As illustrated in FIG. 9, the RFID reader 530 may transmit energy through the first antenna unit 611. In this case, energy may be transmitted in the frequency band of the above-described first RF signal, and the first RF signal may be converted into power by the power harvesting unit 622. The converted power may be stored in the power storage unit 630 or transmitted to other components.

The BLE transceiver unit 540 may transmit energy through the second antenna unit 612. In this case, energy may be transmitted in the frequency band of the above-described second RF signal, and the second RF signal may be converted into power by the power harvesting unit 622. The converted power may be stored in the power storage unit 630 or transmitted to other components.

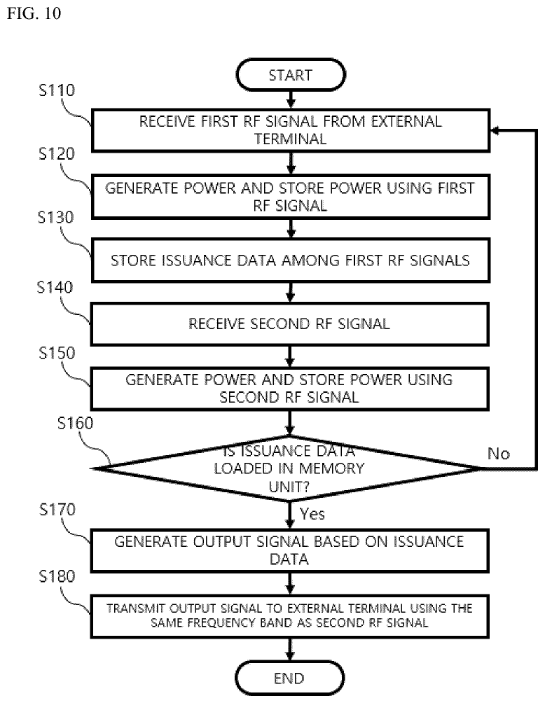

FIG. 10 is a flowchart schematically illustrating a Bluetooth communication method according to an embodiment of the present specification.

For reference, in the description of FIG. 10, contents that are the same or overlapping with the contents described above may be omitted. In addition, the subject performing the communication method of FIG. 10 may be the integrated circuit 600 for Bluetooth communication or the control unit 625 included in the integrated circuit 600 described above. Accordingly, the description of FIG. 10 may be equally applied to FIGS. 5 to 9 described above.

As illustrated in FIG. 10, the Bluetooth communication method according to the embodiment of the present specification may include receiving the first RF signal from the external terminal 500 (S110), generating and storing power using the first RF signal (S120), storing issuance data in the first RF signal in the memory unit 624 (S130), receiving the second RF signal from the external terminal 500 (S140); generating and storing the power using the second RF signal (S150), loading the issuance data from the memory unit 624 (S160), generating an output signal based on the issuance data (S170), and transmitting the output signal to the external terminal 500 using the same frequency band as the second RF signal (S180).

The first RF signal may be received from the external terminal 500 through the first antenna unit 611, the second RF signal may be received from the external terminal 500 through the second antenna unit 612, and the output signal may be transmitted to the external terminal 500 through the antenna unit 613.

The first RF signal may be the frequency band for RFID communication, and the frequency band of the second RF signal may be the frequency band for Bluetooth communication. For example, the frequency band of the first RF signal may be 900 MHz, and the frequency band of the second RF signal may be 2.4 GHz.

The above-described issuance data may include the ADV data including the device information and the BLE control data including the transmission information.

The operation (S110) of receiving the first RF signal from the external terminal 500 may be an operation of receiving the issuance data included in the first RF signal. Alternatively, the operation (S110) of receiving the first RF signal from the external terminal 500 may be an operation of receiving the issuance data included in the first RF signal. The initialization data may initialize the memory unit 624, and as a result, the initialization data may help store newly received issuance data in the memory unit 624 without error.

The operation of receiving the first RF signal from the external terminal 500 (S110) may activate the integrated circuit 600 for Bluetooth communication. That is, the integrated circuit 600 for Bluetooth communication may be activated when receiving the first RF signal, and generate the output signal based on the data stored in the memory unit 624 after activated, and transmit the output signal to the external terminal 500 through the third antenna unit 613.

The operation of receiving the first RF signal from the external terminal 500 (S110) may be an operation of receiving an identifier information request in the first RF signal. The identifier information request may be the ADV data described above. Accordingly, the RFID transceiver unit may respond by transmitting the identifier information stored in the memory unit 624 to the external terminal 500 according to the identifier information request. For example, the external terminal 500 may transmit the issuance data to the integrated circuit 600 for Bluetooth communication when the identifier information matches pre-stored information. In other words, the operation of receiving the first RF signal from the external terminal 500 (S110) is an operation of performing the advertising procedure among the above-described Bluetooth communication procedures, and is an operation of checking whether the identifier information matches the previously stored information.

The operation (S120) of generating and storing power using the first RF signal may be an operation of deriving power according to the first RF signal using the energy harvesting technology and storing the induced power in the power storage unit 630. In addition, the operation (S130) of generating and storing power using the first RF signal may further include converting the induced power into DC power to use the power in another IoT device (not illustrated).

The operation (S130) of storing the issuance data in the first RF signal in the memory unit 624 may include receiving the issuance data in the first RF signal, issuing a pre-allocated area for the issuance data in the memory unit 624 based on the initialization data, and storing the issuance data in the initialized pre-allocated area.

The operation (S140) of receiving the second RF signal from the external terminal 500 may be an operation of receiving wireless power included in the second RF signal. To this end, the second RF signal may be received through a second antenna which is an antenna for receiving wireless power.

The operation (S150) of generating and storing power using the second RF signal may be an operation of deriving power according to the second RF signal using the energy harvesting technology and storing the induced power in the power storage unit 630. In addition, the operation (S150) of generating and storing power using the second RF signal may further include an operation of converting the induced power into DC power to use the power in another IoT device (not illustrated).

The operation of loading the issuance data from the memory unit 624 (S160) may include an operation of the control unit 625 to acquire the information on whether the issuance data is stored in the memory unit 624. When the issuance data is stored in the memory unit 624, the control unit 625 may load the issuance data stored in the memory unit 624. When the issuance data is not stored in the memory unit 624, the control unit 625 may perform the operation (S110) of receiving the first RF signal from the external terminal 500 again.

The operation of generating the output signal based on the issuance data (S170) may generate the output signal based on the BLE control data included in the issuance data. For example, the BLE control data may include the transmission interval information, the transmission power information, the wakeup period information, etc., in the BLE transmitting unit 623. Accordingly, the operation of generating the output signal based on the issuance data (S170) may generate the output signal based on the transmission interval information and the transmission power information. The output signal may have the frequency band of the second RF signal described above. In other words, the operation of generating the output signal based on the issuance data (S170) performs a parameter setup process for the BLE transmission of the output signal. In this case, the performed parameter information may be the transmission interval information, the transmission power information, and the wakeup period information that are included in the BLE control data.

The operation of transmitting the output signal to the external terminal 500 using the same frequency band as the second RF signal (S180) may be an operation of transmitting the output signal to the external terminal 500 through the third antenna unit 613. Specifically, the output signal may be transmitted to the BLE transceiver unit 540 of the external terminal 500.

According to an embodiment of the present specification, it is possible to implement an integrated circuit for Bluetooth communication that is capable of receiving power wirelessly and a Bluetooth communication method using the same.

In addition, according to the present specification, it is possible to implement an integrated circuit for Bluetooth communication that is capable of receiving power wirelessly using signals used in radio frequency identification (RFID) communication and signals used in Bluetooth communication, and a Bluetooth communication method using the same.

In addition, according to the present specification, it is possible to implement an integrated circuit for Bluetooth communication that is capable of receiving ADV data (or device information) required for an advertising procedure using RFID communication, in the integrated circuit for Bluetooth communication that includes a BLE transmitting unit, and a Bluetooth communication method using the same.

Although the present specification has been described with reference to exemplary embodiments illustrated in the accompanying drawings, it is only an example. It will be understood by those skilled in the art that various modifications and other equivalent exemplary embodiments are possible from the present invention. Accordingly, an actual technical protection scope of the present specification is to be defined by the following claims.

What is claimed is:

1. An integrated circuit for Bluetooth communication, comprising:
an antenna unit that receives a first radio frequency (RF) signal and a second RF signal from an external terminal;
a power harvesting unit that generates power based on the first RF signal and the second RF signal;
a radio frequency identification (RFID) tag that receives issuance data and initialization data included in the first RF signal through the antenna unit;
a memory unit that is initialized by the initialization data, receives the issuance data from the RFID tag, and stores the issuance data;
a Bluetooth low energy (BLE) transmitting unit that generates an output signal based on the issuance data and transmits the output signal to the external terminal through the antenna unit;
a control unit that loads the issuance data from the memory unit and controls the BLE transmitting unit based on the issuance data; and
a power storage unit that stores power generated from the power harvesting unit.

2. The integrated circuit of claim 1, wherein the antenna unit includes:
a first antenna unit that receives the first RF signal from the external terminal;
a second antenna unit that receives the second RF signal from the external terminal; and
a third antenna unit that transmits the output signal.

3. The integrated circuit of claim 1, wherein a frequency band of the first RF signal is a frequency band for RFID communication, a frequency band of the second RF signal is the frequency band for Bluetooth communication, and a frequency band of the output signal is a frequency band of the second RF signal.

4. The integrated circuit of claim 1, wherein a frequency band of the first RF signal is 900 MHZ, and a frequency band of the second RF signal is 2.4 GHz.

5. The integrated circuit of claim 1, wherein the issuance data includes advertising (ADV) data including device information and BLE control data including transmission information.

6. The integrated circuit of claim 2, wherein the first antenna unit receives the first RF signal from an RFID reader of the external terminal, the second antenna unit receives the second RF signal from a BLE transceiver unit of the external terminal, and the third antenna unit transmits the output signal to the BLE transceiver unit.

7. A Bluetooth communication method comprising:
receiving a first radio frequency (RF) signal from an external terminal;
generating and storing power using the first RF signal;
storing issuance data in the first RF signal in a memory unit;
receiving a second RF signal from the external terminal;
generating and storing the power using the second RF signal;
loading the issuance data from the memory unit;
generating an output signal based on the issuance data; and
transmitting the output signal to the external terminal using the same frequency band as the second RF signal.

8. The Bluetooth communication method of claim 7, wherein the first RF signal is received through a first antenna unit, the second RF signal is received through a second antenna unit, and the output signal is transmitted through a third antenna unit.

9. The Bluetooth communication method of claim 7, wherein a frequency band of the first RF signal is a frequency band for radio frequency identification (RFID) communication, and a frequency band of the second RF signal is the frequency band for Bluetooth communication.

10. The Bluetooth communication method of claim 7, wherein a frequency band of the first RF signal is 900 MHZ, and a frequency band of the second RF signal is 2.4 GHz.

11. The Bluetooth communication method of claim 7, wherein the issuance data includes advertising (ADV) data including device information and BLE control data including transmission information.

12. The Bluetooth communication method of claim 11, wherein the generating of the output signal based on the issuance data includes performing a parameter setup process for generating the output signal based on the ADV data.
